(19) United States
(12) Patent Application Publication
(10) Pub. No.: US 2016/0191597 A1
(43) Pub. Date: Jun. 30, 2016

(54) AVB SYSTEM DIAGNOSTICS

(71) Applicant: Harman International Industries, Incorporated, Stamford, CT (US)

(72) Inventors: Lejin K. Joy, Bangalore (IN); Nikil Rao, Bangalore (IN)

(21) Appl. No.: 14/583,499

(22) Filed: Dec. 26, 2014

(51) Int. Cl. H04L 29/06

(52) U.S. Cl. CPC H04L 65/608

(57) ABSTRACT

Embodiments are disclosed for a device used in diagnosing errors in an AVB communication system. In some embodiments, a device includes a communication interface communicatively connectable to another device in a communication network and configured to transmit data via the communication network, a processor, and a storage device that stores instructions executable by the processor to collect data from one or more AVB messages transmitted between the device and the other device in the communication network. The instructions are further executable to extract diagnostic data from the one or more AVB messages, and transmit the diagnostic data to an interface device for display.

### FIELD

The disclosure relates to managing AVB systems including running diagnostics routines on AVB devices.

### BACKGROUND

Audio Video Bridging (AVB) is a networking protocol pertaining to streaming audio and/or video data via a network (e.g., an Ethernet network), described in IEEE 802.1 standards (e.g., IEEE802.1BA-2011, IEEE 802.1Q-2011, IEEE 802.1AS-2011, etc.). An AVB network may include one or more talkers (e.g., transmitters) and one or more listeners (e.g., receivers) for transmitting and receiving audio/video data according to the Audio/video transport protocol (AVTP), described in the IEEE 1722-2011 standard.

### SUMMARY

In an AVB network a source stream of data may be configured to carry data intended to be played back at a specific rate and time. The AVB protocol may be utilized for time synchronization of audio and video streams and to ensure that the streams are received correctly. AVB may include four sub-protocols to help achieve such synchronization, including precision time protocol (PTP), audio/video transport protocol (AVTP), stream reservation protocol (SRP) and traffic shaping (Qav). However, once these sub-protocols are implemented in the system, errors may still arise in the system. Errors in the implementation of PTP may lead to an unpredictable system clock, thereby affecting the applications which depend upon precise time synchronization. Errors in the implementation of protocols which involve the actual transmission of streams may also lead to faulty data being received and played.

The disclosure provides methods and systems for analyzing the AVB system (e.g., the AVB system as a whole) periodically to check for any errors in the implementation of the various sub-protocols of AVB. By analyzing the performance of the AVB system in this manner, errors in the system may be diagnosed prior to significant effects on the user experience.

In some embodiments, an example device used for diagnosing errors in an AVB communication system includes a communication interface communicatively connectable to another device in a communication network and configured to transmit data via the communication network, a processor, and a storage device that stores instructions executable by the processor to collect data from one or more AVB messages transmitted between the device and the other device in the communication network. The instructions are further executable to extract diagnostic data from the one or more AVB messages, and transmit the diagnostic data to an interface device for display.

In some embodiments, an example communication system includes a talker device including a transmission buffer for storing audio/video data blocks for transmission, a diagnostic module for collecting AVB protocol data, and a communication interface configured to transmit packets via an AVB network. The example communication system further includes a listener device communicatively connected to the talker device and configured to receive the generated packets from the talker device, and an interface device communicatively connected to the talker device, the interface device including a display and configured to receive and display information corresponding to the collected AVB protocol data.

According to some embodiments, an example method for diagnosing errors in an AVB communication system includes collecting, via an interface device of the AVB communication system, AVB protocol data from one or more diagnostic modules in an AVB communication system, each of the one or more diagnostic modules being included in a talker or a listener device of the AVB communication system, and analyzing the collected data to determine whether errors are present in the AVB communication system. The example method further includes displaying, via a display device of the interface device, the collected data including an indication of any errors determined to be present during analysis of the collected data.

### BRIEF DESCRIPTION OF THE DRAWINGS

The disclosure may be better understood from reading the following description of non-limiting embodiments, with reference to the attached drawings, wherein below:

FIG. 1 shows an example partial view of a vehicle cabin in accordance with one or more embodiments of the present disclosure;

FIG. 2 shows an example communication system in accordance with one or more embodiments of the present disclosure;

FIG. 3 shows an example configuration of a talker device and a listener device of FIG. 2 in accordance with one or more embodiments of the present disclosure;

FIG. 4 shows an example packet structure in accordance with one or more embodiments of the present disclosure;

FIG. 5 is a flow chart for an example method for displaying information for diagnosing errors in a communication system in accordance with one or more embodiments of the present disclosure;

FIG. 6 is a flow chart for an example method of collecting information resulting from one or more devices in a communication network in accordance with one or more embodiments of the present disclosure;

FIG. 7 is a flow chart for an example method of collecting information resulting from one or more devices in a communication network in accordance with one or more embodiments of the present disclosure;

FIG. 8 is a flow chart for an example method of diagnosing errors in an AVB communication system in accordance with one or more embodiments of the present disclosure; and

FIG. 9 is an example user interface for displaying diagnostic data in accordance with one or more embodiments of the present disclosure.

### DETAILED DESCRIPTION

As described above, a communication system may include talker and listener devices. The listener devices may receive audio/video streams from the talker devices and playback each received packet of the audio/video streams at a presentation time identified in the received packet. However, if the errors in the AVB system arise, the listener may no longer be synchronized with the talker, data may be lost or degraded, and overall user experience may degrade as audio/video data playback is disrupted. Thus, in typical AVB systems, errors in the system are first identified and diagnosed based on a degraded user experience as perceived by a user of the system. A new AVB protocol for diagnosing errors in an AVB system and/or analyzing the performance of the AVB system is described in more detail below. In the new protocol described below, data from the execution of each sub-protocol for an AVB system may be captured to determine the presence of errors in the system. For example, a user may view the captured data and determine the presence of errors in the system, or the data may be automatically analyzed to determine the presence of errors in the system. In either case, the protocol described below may enable errors to be diagnosed before the user experience degrades significantly.

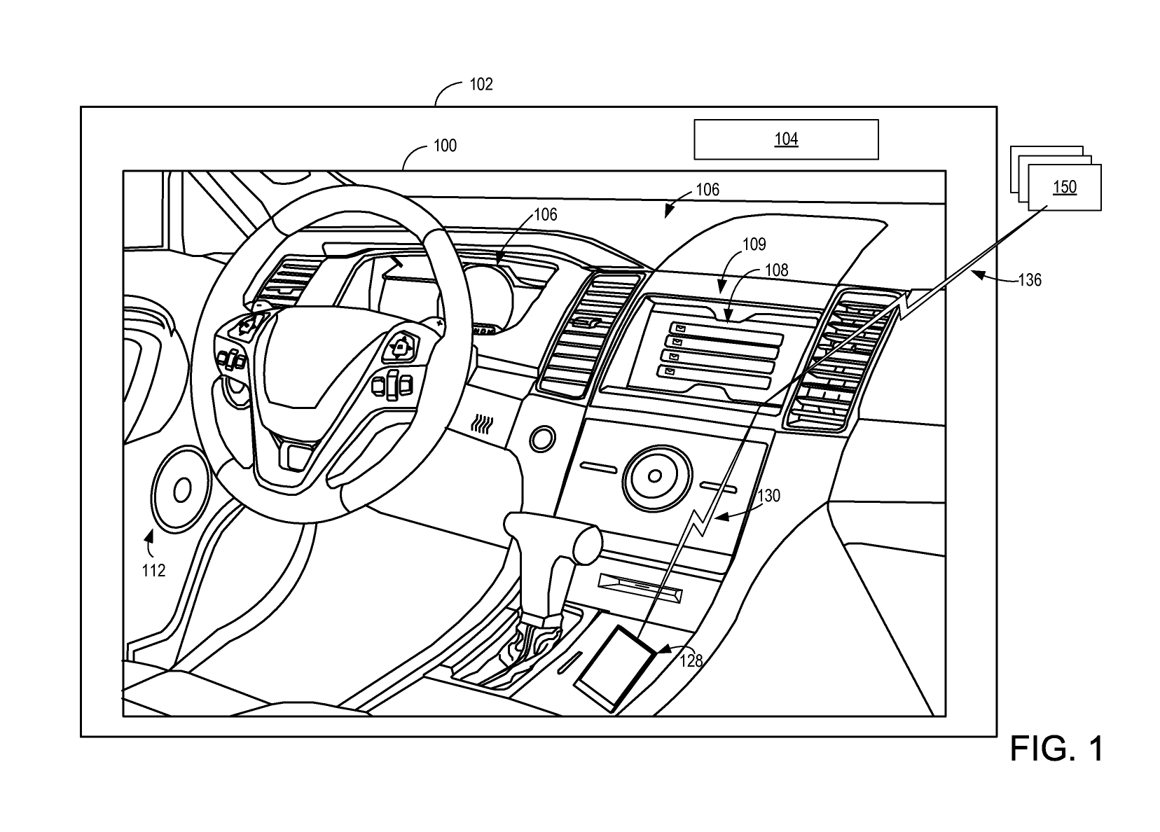

FIG. 1 shows an example partial view of one type of environment for a communication system: an interior of a cabin 100 of a vehicle 102, in which a driver and/or one or more passengers may be seated. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a driver (also referred to as the user) of vehicle 102. For example, instrument panel 106 may include a touch screen 108 of an in-vehicle computing system 109 (e.g., an infotainment system), an audio system control panel, and an instrument cluster 110. While the example system shown in FIG. 1 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128.

In some embodiments, one or more hardware elements of in-vehicle computing system 109, such as touch screen 108, a display screen, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system may be modular and may be installed in multiple locations of the vehicle.

The cabin 100 may include one or more sensors for monitoring the vehicle, the user, and/or the environment. For example, the cabin 100 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 100, etc. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as from sensors coupled to external devices 150 and/or mobile device 128.

Cabin 100 may also include one or more user objects, such as mobile device 128, that are stored in the vehicle before, during, and/or after travelling. The mobile device may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], etc.) or wireless (e.g., via BLUETOOTH, WI-FI, Near-Field Communication [NFC], cellular connectivity, etc.) and configured to provide two-way communication between the mobile device and the in-vehicle computing system. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices 150 are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108.

In-vehicle computing system 109 may analyze the input received from external devices 150, mobile device 128, and/or other input sources and select settings for various in-vehicle systems (such as climate control system or audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

In the example environment illustrated in FIG. 1, the in-vehicle computing system 109 may be connected to one or more vehicle systems, such as speakers 112, display 108, vehicle sensors, and/or other suitable vehicle systems via any suitable network. In some examples, the in-vehicle computing system 109 includes a talker device configured to transmit audio/video data to listener devices, such as speakers 112 and display 108 via a network. The network may be configured in accordance with Layer 2 of the Open Systems Interconnection (OSI) model, in which routing and forwarding decisions or determinations in the network may be performed on a media access control (MAC) addressing basis. An example Layer 2 network may be an Ethernet Audio/Video Bridging (AVB) network. For Layer 2 networks configured as AVB networks, the talkers and the listeners may be configured to communicate over the AVB network using various AVB standards and protocols, including the Institute of Electrical and Electronics Engineers (IEEE) 802.1AS-2011 (gPTP) for network timing and synchronization, IEEE 802.1Q-2011 clause 34/IEEE 802.1Qav-2009 (Qav) for queuing and forwarding streaming data, IEEE 802.1Q-2011 clause 35 (Stream Reservation Protocol (SRP)) for reserving a network connection or path and/or resources such as bandwidth for communication over the network connection, and/or IEEE 1722-2011 (audio/video transport protocol (AVTP)) related to a possible data streaming format. Other AVB-related standards and protocols, and/or other versions of the AVB standards and protocols, previously, currently, or later developed, may also or alternatively be used.

The in-vehicle computing system may stream audio/video data based on information stored in local storage and/or audio/video data received from mobile device 128 and/or external device(s) 150. Transmitting audio/video data having a proper number of sample chunks within each packet may ensure that the audio/video data is presenting via the speakers 112 and/or display 108 at a proper media rate (e.g., without audio distortions that may arise from samples being skipped or played too early/late).

It is to be understood that FIG. 1 depicts one example environment, however the communication systems and methods described herein may be utilized in any suitable environment. As another example, speakers in a professional audio environment (e.g., an arena, stadium, concert hall, amphitheater, recording studio, etc.) may be utilized as listeners that receive audio data from a talker device (e.g., a mixing console, audio/video receiver, etc.) over an AVB network. Any suitable devices that transmit and/or receive packets may be utilized as the systems and/or to perform the methods described herein.

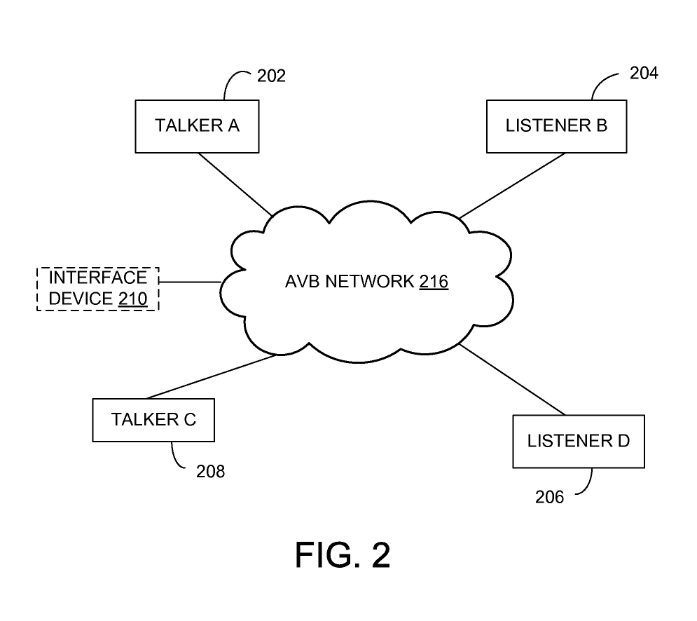

FIG. 2 is an example communication system 200 including a plurality of talkers (e.g., talkers 202 and 208) and a plurality of listeners (e.g., listeners 204 and 206). As described above, each of the talkers may be any suitable device for sending an audio/video stream to one or more of the listeners. Each of the listeners may be any suitable device for receiving and playing back the audio/video stream received from one or more of the talkers. For example, talker 202 may correspond to in-vehicle computing system 109 and listener 204 may correspond to speakers 112 and/or display 108 of FIG. 1. In some examples, one or more of the talkers and/or listeners may be configured to be an interface device for collecting AVB data and displaying the collected data to a user for diagnosing errors in the communication system. In additional or alternative examples, an interface device 210 may be connected to the AVB network and/or connected to one or more of the talkers/listeners directly and/or through AVB network 216. Although illustrated as talkers/listeners/interface devices, it is to be understood that one or more devices in the communication system 200 (e.g., any of talkers/listeners/interface devices 202-210) may be configured to perform multiple roles. For example, one or more devices in the system may both transmit audio/video data and receive audio/video data, thereby selectively taking on the role of a talker and a listener. The role of the talker may be to transmit information and/or data across AVB network 216. Additionally or alternatively, the role of the talker may include establishing, creating, and/or reserving a connection for the transmission of a data stream carrying the information and/or data. Additionally or alternatively, the role of the talker may be to remove or tear down the connection. The role of the listener may be to receive the information and/or the data that has been sent over network 216. Additionally or alternatively, the role of the listener may include connecting to and/or reserving a connection to the data stream. Additionally or alternatively, the role of the listener may include removing a connection to the data stream. The role of the talker/listener may be to perform both the role of the talker and the listener, either at the same time or at different times.

The devices may also take on other roles, including but not limited to a client role, a controller, a master clock device, etc. The role of the controller may include controlling the flow of the data stream between the talker and the listener or the talker/listener. The controller may control the flow of the data stream by sending one or more messages to the talker, the listener, and/or the talker/listener to create a connection and/or remove the connection of the data stream between the talker and the listener or the talker/listener. The messages may be communicated to the talker, the listener, and/or the talker/listener through a high-level application layer of the talker, the listener, and/or the talker/listener. Additionally or alternatively, the role of the controller may be to identify and/or determine which of the talkers are of importance, relevant to, and/or expected to be used by a listener. The role of the client may include determining an input, such as a user input, indicative of the creation or the removal of the connection of the data stream and communicating the input to the controller.

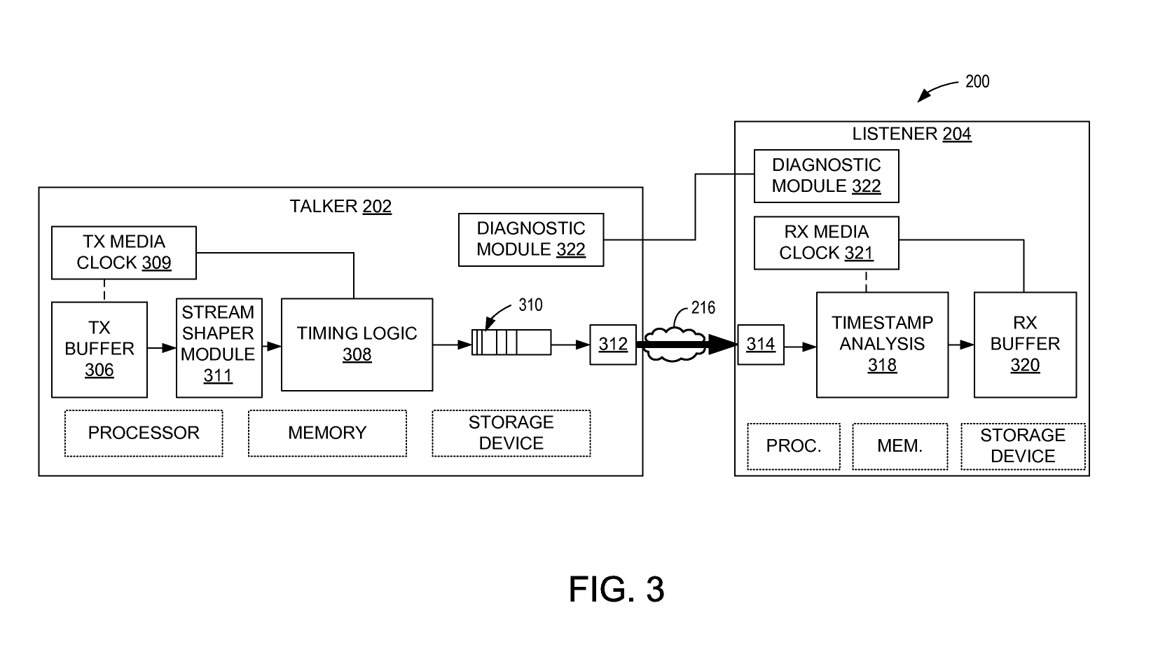

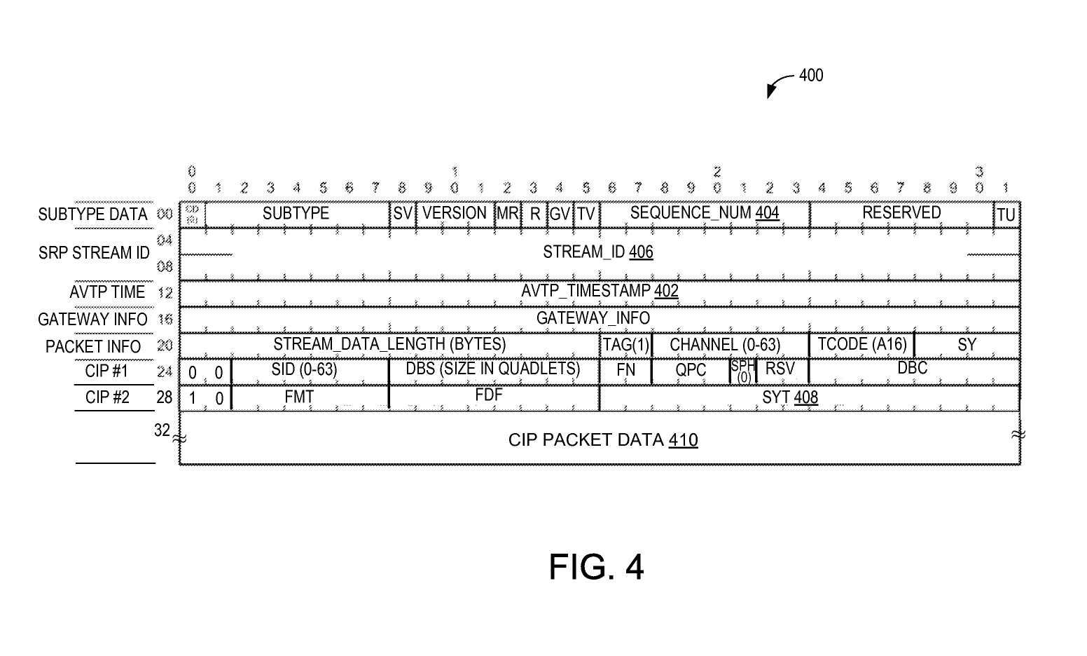

FIG. 3 illustrates an example configuration of talker 202 and listener 204 of FIG. 2. As illustrated, talker 202 may include a transmission buffer 306 configured to store data blocks of an audio/video stream. For example, if the audio/video stream is supplied from an external device (e.g., external device 150 and/or mobile device 128 of FIG. 1), the received data may be stored in transmission buffer 306 until the data is ready to be processed by a stream shaper module 311 and a timing logic module 308. Stream shaper module 311 (e.g., in combination with the timing logic 308 and/or another suitable module of talker 202, such as a packetizer, communication interface 312, etc.) may encapsulate one or more samples in a packet 310 including header information indicating a presentation time. An example packet structure is illustrated in FIG. 4 and described in more detail below.

Once stream shaper module 311 configures the samples for inclusion in the packet, the presentation time and/or other timestamps may be calculated and/or verified by timing logic 308. The presentation time may be calculated based on a clock signal from transmission media clock 309. The timing information used for calculating the presentation time may be determined by executing a precision time protocol (PTP) stack.

The packet 310 may be transmitted from talker 202 (e.g., via a talker communication interface 312) to a listener 204 (e.g., via a listener communication interface 314) over a network (e.g., an AVB network 216). Accordingly, talker communication interface 312 and listener communication interface 314 may be configured to communicate via an AVB network (e.g., via the audio/video transport protocol, AVTP). Packet 310, as received at listener 204, may be provided to a timestamp analysis module 318. Timestamp analysis module 318 may include instructions executable by a processor of listener 204 to evaluate the header of received packets (e.g., of packet 310) to determine a value of one or more timestamps in the header. The packet may be stored at receive buffer 320 in an index that is based on the presentation time included in the packet. The listener 204 may play out audio/video data from receive buffer 320 based on the index at which each data block is stored and/or when a receive media clock 321 of the listener reaches the presentation time indicated for a given data block.

In some examples, the presentation time may be utilized to synchronize the receive media clock 321 with the transmission media clock 309. For example, if the network delay (e.g., the max transit time) is known by both the talker and the listener, the listener may compare a receive time with an expected receive time (e.g., based on a known transmission delay and the presentation time) and adjust the receive media clock based on a calculated error (e.g., the difference between the measured receive time and the expected receive time).

It is to be understood that one or more of the components of talker 202 and listener 204 may include and/or be included in a processor and/or storage device of talker 202 and listener 204. For example, although a processor/memory/storage device is illustrated separately within talker 202 and listener 204, it is to be understood that transmission buffer 306 may include at least a portion of a storage device of talker 202, and timing logic 308 may include instructions stored in the storage device of talker 202 and/or a processor for executing the instructions stored in the storage device of talker 202. Likewise, receive buffer 320 may include at least a portion of a storage device of listener 204, and timestamp analysis module 318 may include instructions stored in the storage device of listener 204 and/or a processor for executing the instructions stored in the storage device of listener 204.

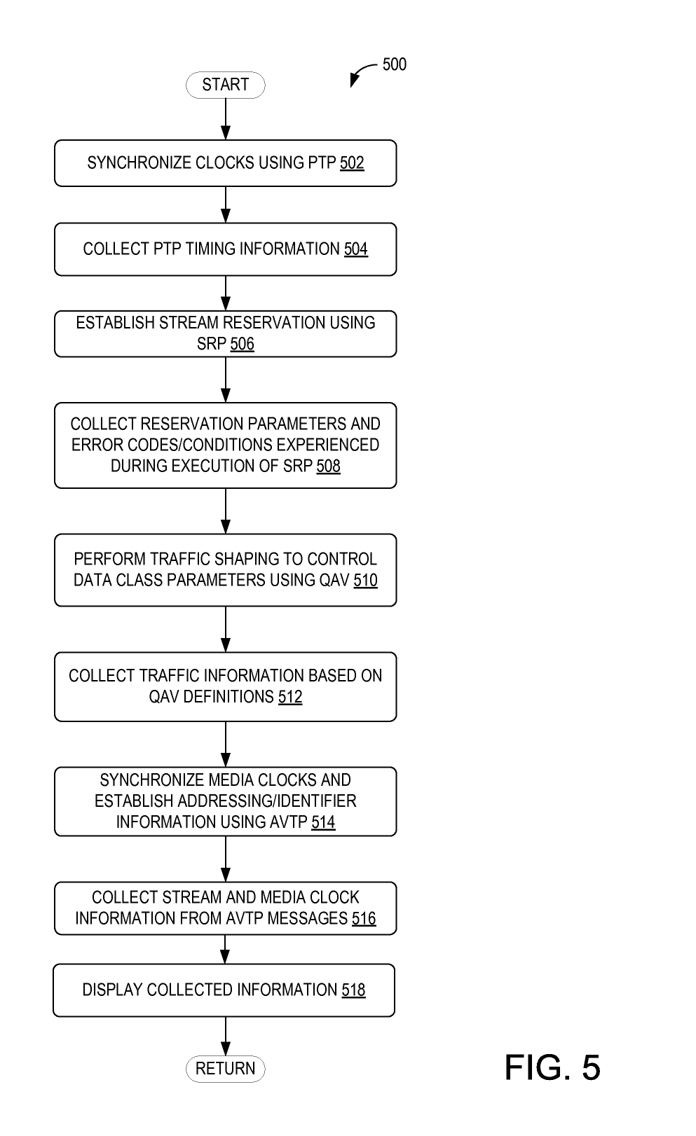

One or more of the above-described elements of talker 202 and listener 204 may be operated to provide PTP, AVTP, SRP, QAV, and/or other AVB protocols and services on the devices. One or more devices in the AVB communication system may include a diagnostic module for performing data collection at that device. For example, diagnostic modules 322 and 324 may be configured to intercept messages that are transmitted to perform clock synchronization and analyze the messages in order to extract timing information relating to the PTP synchronization routine. Further, the diagnostic modules 322 and 324 may communicate with one another in order to provide a global perspective of the communication system. Additional actions that may be performed by the diagnostic module are described below with respect to FIGS. 5-8.

FIG. 4 illustrates an example packet 400 including a presentation time (e.g., AVTP_TIMESTAMP field 402). For example, packet 400 may illustrate an example structure of packet 310 of FIG. 3. Other fields of note may include the SEQUENCE_NUM field 404, which may indicate a place of the packet in the audio/video stream (e.g., how many packets were sent before that packet in the current audio/video stream). STREAM_ID field 406 may indicate an identifier for the stream, which designates the stream to which the packet belongs. As described above, AVTP_TIMESTAMP field 402 indicates a time at which the packet is to be played back (e.g., a real time and/or a time that is reachable by a media clock of a listener). SYT field 408 may indicate a SYT_INTERVAL, which denotes the number of data blocks between two successive valid AVTP_TIMESTAMP fields. CIP PACKET DATA field 410 may include the payload of the packet (e.g., while each of the other fields illustrated in FIG. 4 and/or described above make up the header of the packet). For example, CIP PACKET DATA field 410 may include the audio/video data blocks/samples to be played back at the time indicated in the AVTP_TIMESTAMP field 402.

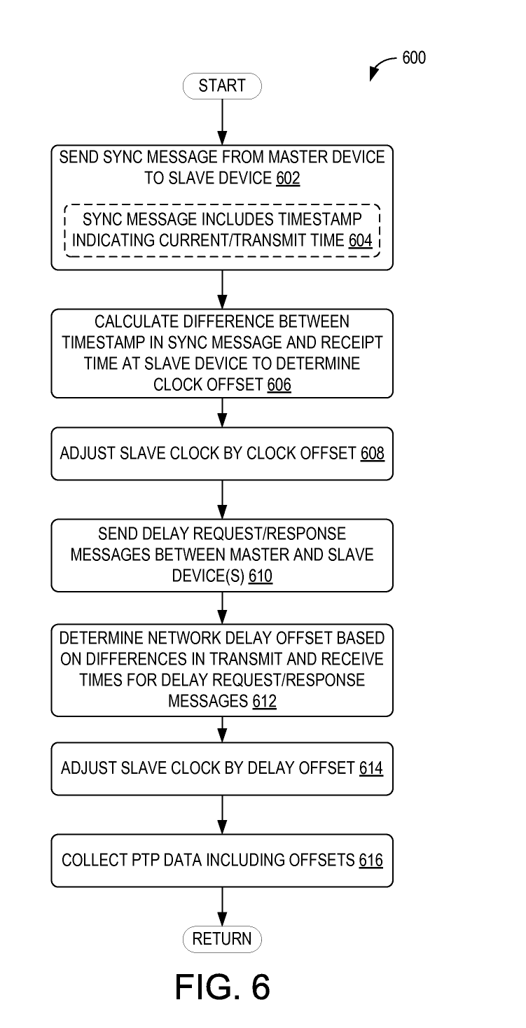

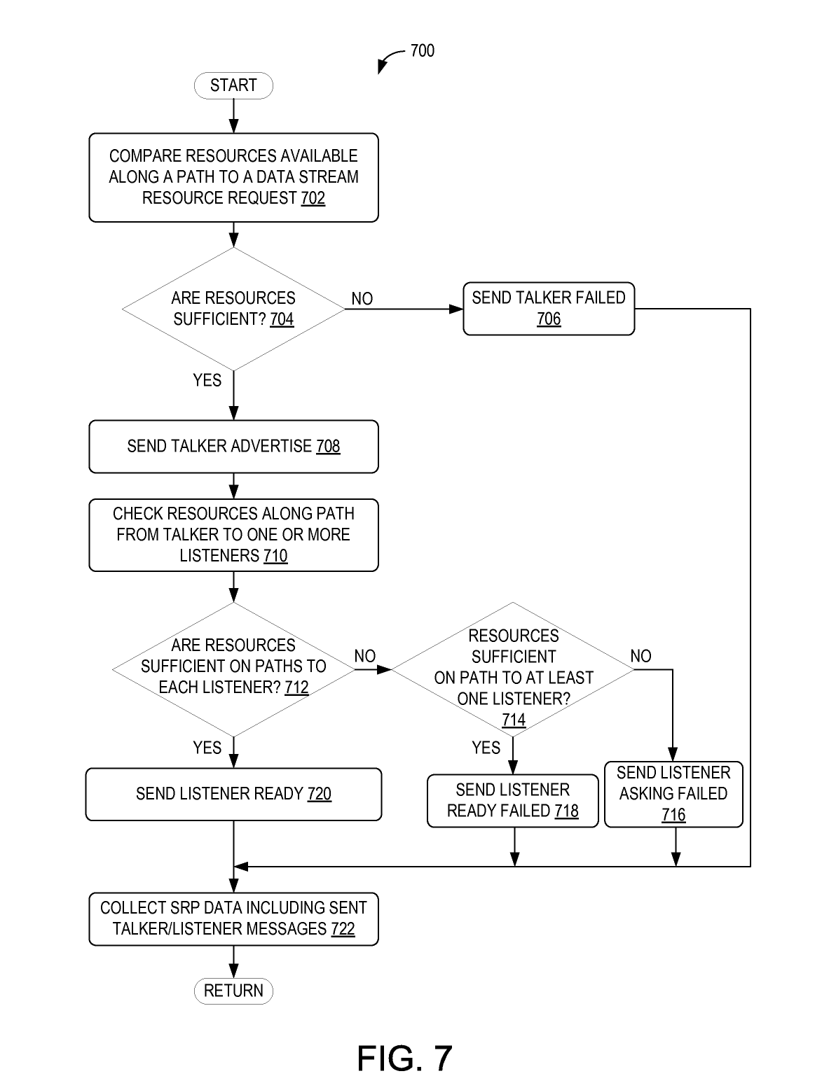

FIG. 5 is a flow chart of a method 500 for displaying information for diagnosing errors in a communication system, such as communication system 200 of FIG. 2. At 502, method 500 includes synchronizing clocks in the communication system using PTP. At 504, the method includes collecting PTP timing information. An example of clock synchronization and associated information collection is described below with respect to FIG. 6. At 506, the method includes establishing a stream reservation between at least two devices in the communication system using SRP. At 508, the method includes collecting reservation parameters and error codes/conditions experienced during execution of the SRP. An example of SRP execution and associated data collection is described below with respect to FIG. 7.

At 510, the method includes performing traffic shaping to control data class parameters using Qav. The traffic shaping may be performed during SRP execution and may include defining a percentage of bandwidth to provide to each traffic class. At 512, the method includes collecting traffic information based on the Qav definitions. At 514, the method includes synchronizing media clocks and establishing addressing/identifier information using AVTP. At 516, the method includes collecting stream and media clock in formation from the AVTP messages.

At 518, the method includes displaying the collected information. By displaying the information collected during AVB communication system configuration and data stream set-up/transmission, a user may view the data to identify errors before the errors present as a degraded user experience (e.g., distorted/laggy audio/video data, etc.). While each step of method 500 may be performed by one or more devices in the system, it is to be understood that one or more devices in the system (e.g., each device in the system) may include a diagnostic module for performing data collection at that device. For example, messages that are transmitted to perform clock synchronization may be intercepted, stored (e.g., temporarily), and analyzed by the diagnostic module within a receiving device in order to extract timing information relating to the PTP synchronization routine. Although illustrated in a linear fashion, it is to be understood that the collection and display of data may occur in near real-time as the data is generated (e.g., as messages are communicated/intercepted by the diagnostic module) and/or periodically throughout operation of the devices on the AVB network. Further, the diagnostic module in each device may communicate with diagnostic modules in other devices in order to provide a global perspective of the communication system. The data collected at each diagnostic module may be transmitted to an interface system, which may be an external device and/or one of the devices that include the diagnostic module. The interface system may include a display for presenting the collected data to a user.

FIG. 6 is a flow chart of a method 600 for collecting information resulting from one or more devices in a communication network, such as communication network 200 of FIG. 2, performing a time synchronization routine in accordance with PTP. It is to be understood that method 600 is not an exhaustive representation of messages that may be sent during PTP time synchronization, and that additional or alternative actions may occur and/or be collected for providing diagnostic data for the system. At 602, the method includes sending a sync message from a master device to a slave device. For example, the sync message may include a timestamp indicating the current time (e.g., an estimated or precise current PTP time indicated by a master PTP clock) and/or a transmit time for the message, as indicated at 604. At 606, the method includes calculating, at the slave device, a difference between the timestamp in the sync message (e.g., the current PTP time) and the current/receipt time at the slave device to determine a clock offset. At 608, the method includes adjusting the slave clock (e.g., a local media clock of the slave device, such as transmission media clock 309 of FIG. 3) by the clock offset.

At 610, the method includes sending delay request/response messages between the master and slave devices. At 612, the method includes determining a network delay offset based on differences in transmit and receive times for the delay request/response messages. At 614, the method includes adjusting the slave clock by the delay offset. For example, by adjusting the slave clock by the clock offset at 608, the local clock of the slave device is set to the same time as the master clock, as long as a network delay of null is assumed. Accordingly, the delay request/response messages sent after adjusting the clock based on the sync message will only show differences in transmit/receive times that arise due to network delays. Adjusting the slave clock by the delay offset ensures that the local clock is properly synced to the master clock of the master device.

At 616, the method includes collecting PTP data including the offsets determined at 608 and 614. For example, the offsets may indicate a local clock drift (e.g., an amount of change of the local clock from the master clock over time) and/or a network delay in the system. Other data that may be collected during PTP operation may include Linkdelay (e.g., the time spent by the stream on the wire), asCapable Ports/devices connected (e.g., a port/node/device in an AVB network is ASCapable if the link delay is less than a specified maximum value, such as 500 ns), PTP lock status with each slave device (e.g., the Grandmaster in the AVB system sends out Sync and follow-up messages to other devices in the system for clock synchronization—PTP lock exists between two devices one the frequency of the slave is within an acceptable range as that of the Grandmaster), neighbourRateRatio (e.g., as device present in an AVB network may be using clocks running at different frequencies, the neighbourRateRatio is calculated between neighboring devices to compensate for the frequency difference and synchronize both clocks), rateRatio (e.g., for compensating for the frequency difference between the Grandmaster clock and all devices in the AVB network), pDelayReqInterval value (e.g., messages used in calculation of Linkdelay, the frequency of which determines how often the linkdelay is calculated), SynchInterval value (e.g., the frequency with which the grandmaster sends Sync messages to the slaves in the AVB network, which determines how fast the slaves acquire a PTP lock to the Grandmaster and affects the timing accuracy of the system as a whole), and/or any other suitable PTP-related data.

The electronic devices that communicate data streams in the above-described examples may first establish a reservation for the data stream communication. Upon startup, the devices may attain a link status, which enables the devices to communicate with peer nodes or devices in the system. After link status is attained, the devices may be initialized with a reservation protocol. For Audio-Video Bridging networks, the reservation protocol may be Stream Reservation Protocol (SRP). The initialization process may include a domain negotiation in which domain packets may be communicated with peer nodes. After the initialization process is performed, the devices may establish a reservation for the data stream communication. The reservation may be a reservation for a network path through the network and/or for network resources such as bandwidth, which may be guaranteed during communication of the data stream. Where a reservation protocol is used, messages may be communicated between the talkers and the listeners (e.g., through bridges) in accordance with the reservation protocol to establish the reservation. Once the reservation is established, the data stream may be communicated over the network.

FIG. 7 is a flow chart of a method 700 for collecting information resulting from one or more devices in a communication network, such as communication network 200 of FIG. 2, performing an SRP routine to reserve network resources for a data stream. At 702, method 700 includes comparing resources available along a path (e.g., from a data source to a talker device) to a data stream resource request (e.g., an amount of resources associated with a particular data stream to be sent over the path). At 704, the method includes determining if the available resources are sufficient for transmitting the data stream. For example, the resources may be sufficient if the data stream is able to be sent according to a quality of service (QoS) requirement for that data stream. If the available resources are not sufficient (e.g., “NO” at 704), the talker transmits a talker failed message, as indicated at 706. Conversely, if the available resources are sufficient (e.g., “YES” at 704), the talker sends a talker advertise message advertising the data stream, as indicated at 708.

At 710, the method includes checking resources along a path (or along each path) from the talker to one or more listeners. At 712, the method includes determining whether the resources of each path are sufficient (e.g., if there exists, for each listener, at least one path between the talker and that listener that includes sufficient resources for accommodating the data stream [e.g., according to the QoS requirements for that data stream]). If the resources for each path are not sufficient (e.g., “NO” at 712), the method proceeds to 714 to determine whether at least one of the paths to the listeners includes sufficient resources. If not (e.g., if none of the paths between the talker and the listeners has sufficient resources, “NO” at 714), a listener asking failed message is transmitted from the listener to the talker (and/or to a client and/or controller in the communication system), as indicated at 716. Otherwise, if at least one path between the talker and at least one listener has sufficient resources for the data stream (e.g., “YES” at 714), a listener ready failed message is transmitted from the listener to the talker (and/or to a client and/or controller in the communication system), as indicated at 718. Returning to 712, if the resources are sufficient on paths to each listener (e.g., if there exists, for each listener, at least one path between the talker and that listener that has sufficient resources for the data stream, e.g., “YES” at 712), a listener ready is transmitted from the listener to the talker (and/or to a client and/or controller in the communication system), as indicated at 720. The determination of sufficient resources may be based on an indication of the requested resources in the talker advertise and/or a predetermined parameter of sufficient resources for data streams in the communication system.

At 722, the method includes collecting SRP data including the sent talker/listener messages indicating the resource availability. Other SRP data that may be collected includes an indication of a Stream Reservation Path, Stream ID, Stream DA, VID, MaxFrameSize (e.g., a maximum frame size for data sent via the reserved path), MaxIntervalFrames (e.g., a maximum frame interval for data sent via the reserved path), priority (e.g., of the data stream, the reserved path, the devices, etc.), rank, accumulated latency (e.g., in the network, along the reserved path, etc.), composition of super streams, ingress/egress ports for all streams, and/or any other suitable SRP-related data.

As described above with respect to FIG. 5, data similar to the PTP and SRP data described above may be collected with regards to Qav and AVTP routines. Example Qav data collected may include bandwidth configuration per port/per traffic class basis, real-time traffic rate, packet priority type, traffic class, total bandwidth, transmission selection algorithm, and/or any other suitable Qav-related data. Example AVTP data collected may include stream ID of streams, SR Class of the traffic flowing through the device, bandwidth reserved for each stream, stream payload size, format and data, bits per sample, inter frame gap, and/or any other suitable AVTP-related data.

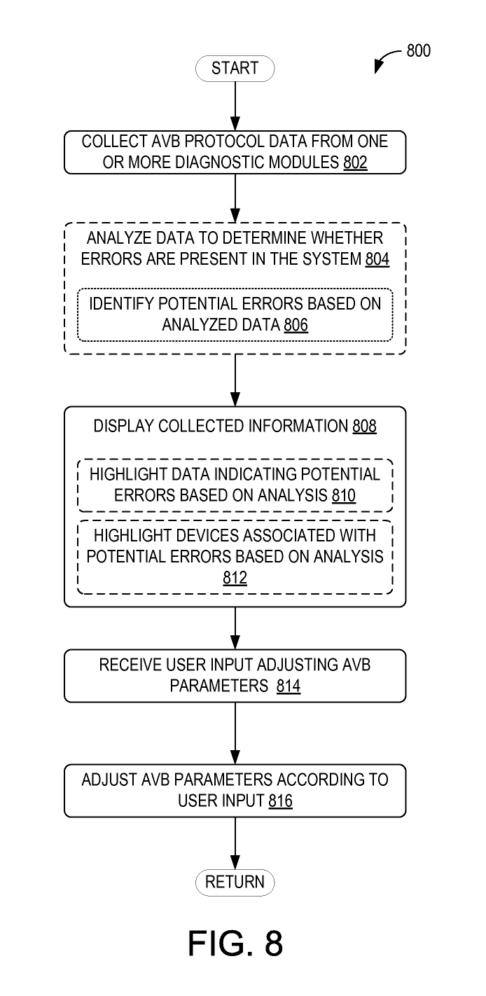

FIG. 8 is an example method 800 for diagnosing errors in an AVB communication system. Method 800 may be performed by any suitable device, including but not limited to an interface device (e.g., interface device 210 of FIG. 2), which may be an external device and/or a device (e.g., one of the talker/listener devices of FIG. 2) that includes a diagnostic module. At 802, the method includes collecting AVB protocol data (e.g., any suitable data describing parameters/conditions/configurations of the AVB system, including but not limited to the data described above with respect to FIGS. 5-7) from one or more diagnostic modules in the communication system. At 804, the method optionally includes automatically analyzing the data (e.g., with the device that collected the AVB protocol data at 802 and/or with a remote device communicatively connected to the device that collected the AVB protocol data at 802) to determine whether errors are present in the system. For example, potential errors may be identified (e.g., an estimated likelihood of errors being present based on the analyzed data) as indicated at 806. In some examples, analyzing the collected data may include comparing the data collected from one or more AVB-related messages or other data sources (e.g., messages transmitted during operation according to PTP, SRP, Qav, AVTP, etc.) to expected data and identifying differences in the collected data from the expected data that exceed a threshold.

At 808, method 800 includes displaying the collected information. The information may be displayed on a display of the interface device to allow a user to determine the status of the communication system and/or diagnose errors in the system. As indicated at 810, data indicating potential errors (e.g., as identified by the analysis at 804/806) may be highlighted to draw the user's attention to such elements. Additionally or alternatively, devices that are associated with potential errors may be highlighted based on the analysis performed at 804/806, as indicated at 812. In this way, the interface system may determine potential discrepancies in the data and/or identify potential errors in the system based on the data, and the user may confirm that the data is indicative of errors in the system. For example, based on PTP timing information collected during PTP clock synchronization, the interface system and/or the user may determine that a clock offset applied to synchronize the clocks is higher than a threshold, indicating an unexpected amount of drift in the clock of the slave device. Accordingly, displaying the collected information may include highlighting the listener device experiencing the larger-than-expected clock drift.

In response to identifying errors in the AVB system, the user may provide input to adjust one or more AVB parameters, as indicated at 814. At 816, the method includes adjusting the AVB parameters according to the user input. Continuing with the example above, the user may provide instructions to compensate for the irregular clock drift. The interface device may process and/or propagate the user input as control commands to adjust operation of one or more devices in the AVB communication system.

AVTP is the protocol by which the audio data is packed into streams and sent between two devices. As another example of identifying errors in the AVB system, if there are discrepancies when packing the data into the streams, audio might play but there might be distortions heard in between audio playback. Analyzing the stream data may be useful in these cases to find out if the errors have occurred due to faulty data being packed into the stream. The timing obtained from the PTP is packed into the streams and if there is a mistake while copying this time to the streams the audio may play at a different speed than the original. As another example, problems may arise in playing the audio if enough bandwidth is not reserved for AVB audio traffic using QAV. The ability to obtain information about the bandwidth reservations and also to change these values may be useful to decide if the problems are through faulty implementation of QAV.

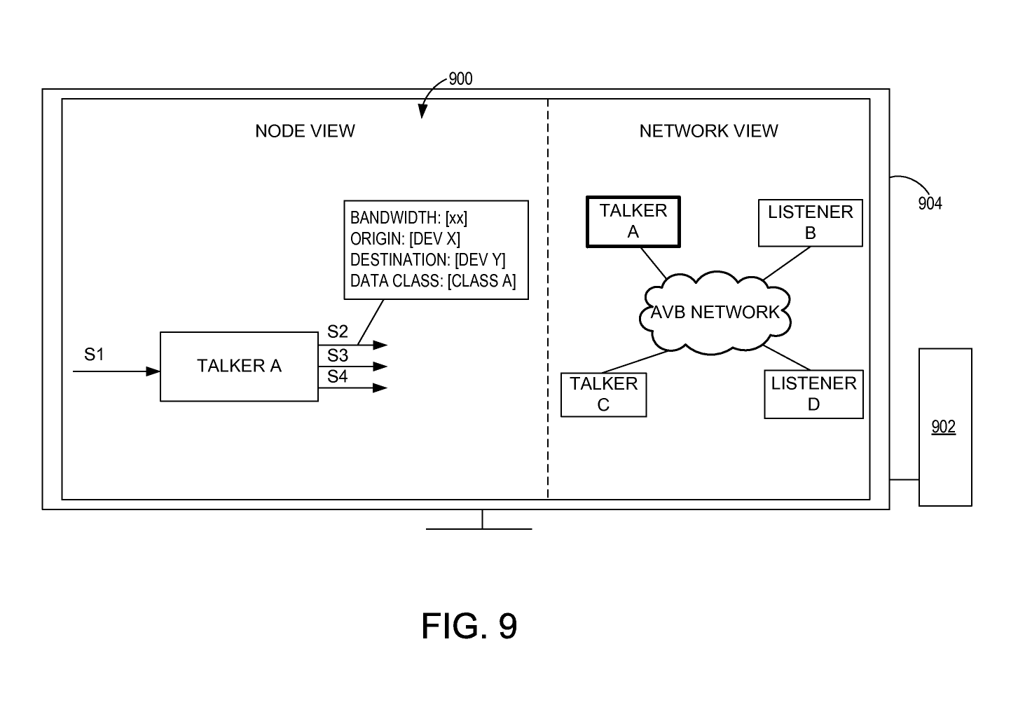

FIG. 9 illustrates an example user interface 900 of an interface device 902 for displaying diagnostic data (e.g., data collected and/or analyzed as described above with respect to FIGS. 5-8). Interface device 902 may be an example of interface device 210 of FIG. 2 in some examples. As illustrated, user interface 900 includes a graphical user interface displayed on display 904 of interface device 902. It is to be understood that any suitable interface may be utilized to present the collected AVB data to the user, including audio interfaces (e.g., in which the collected AVB data is output from an audio device), control panels (e.g., in which LED or other lights/light arrays are used to indicate AVB system status), and/or any suitable combination of interfaces.

In the example illustrated in FIG. 9, user interface 900 is split into a node view (e.g., in which a single node of a communication system is displayed) and a network view (e.g., in which all and/or a plurality of nodes of the communication are displayed). The node view may provide detailed information regarding a particular node, streams input/output to/from the node, and/or other operational data. The network view may provide relationship information regarding connections between the nodes, a brief overview of the status of the nodes, functions of each node (e.g., which nodes are talkers, which nodes are listeners, etc.), and/or any other suitable data. It is to be understood that the user interface illustrated in FIG. 9 is exemplary in nature, and any suitable arrangement of data may be presented in other examples. For example, the node view and the network view may only be accessible at different times (e.g., instead of the split-screen view illustrated in FIG. 9) and selectable by a menu option. Further, additional or alternative data may be displayed in each view, and additional or alternative views of the communication system and/or individual node(s) may be presented.

By collecting and displaying AVB-related data as described above, the system and/or a user is able to ensure that the communication system is operating normally (e.g., without errors) and/or determine errors prior to a point at which the errors cause a perceivable degrade in the user experiences. In this way, errors may be diagnosed and potentially corrected before user experience is degraded.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the in-vehicle computing system 109 and/or talker 202/listener 204 described with reference to FIGS. 1 and 2. The methods may be performed by executing stored instructions with one or more logic devices (e.g., processors) in combination with one or more additional hardware elements, such as storage devices, memory, hardware network interfaces/antennas, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A device comprising:
a communication interface communicatively connectable to another device in a communication network and configured to transmit data via the communication network;
a processor; and
a storage device that stores instructions executable by the processor to:
collect data from one or more AVB messages transmitted between the device and the other device in the communication network;
extract diagnostic data from the one or more AVB messages; and
transmit the diagnostic data to an interface device for display.

2. The device of claim 1, wherein the one or more AVB messages include messages transmitted during clock synchronization according to precision time protocol (PTP).

3. The device of claim 1, wherein the one or more AVB messages include messages transmitted during a stream reservation process according to stream reservation protocol (SRP).

4. The device of claim 1, wherein the one or more AVB messages include traffic shaping messages according to IEEE 802.1Qav.

5. The device of claim 1, wherein the one or more AVB messages include messages transmitted in accordance with audio video transport protocol (AVTP).

6. The device of claim 1, wherein the device is a talker device of the communication network and wherein the interface device is local and directly connected to the talker device.

7. The device of claim 1, wherein the device is a talker device of the communication network and wherein the interface device is remote and connected to the talker device via the communication network.

8. The device of claim 1, wherein the instructions are further executable to analyze the data to determine whether errors are present in one or more devices of the communication network.

9. The device of claim 8, wherein the interface device is configured to display the diagnostic data and indicate any errors determined by the analysis of the data.

10. A communication system comprising:
a talker device including:
a transmission buffer for storing audio/video data blocks for transmission,
a diagnostic module for collecting AVB protocol data, and
a communication interface configured to transmit packets via an AVB network;
a listener device communicatively connected to the talker device and configured to receive the generated packets from the talker device; and
an interface device communicatively connected to the talker device, the interface device including a display and configured to receive and display information corresponding to the collected AVB protocol data.

11. The system of claim 10, wherein the diagnostic module is a first diagnostic module, the listener device further comprising a second diagnostic module for collecting AVB protocol data.

12. The system of claim 11, wherein the talker device includes instructions executable by a processor of the talker device to transmit collected AVB protocol data to the listener device and wherein the listener device includes instructions executable by a processor of the listener device to transmit collected AVB protocol data to the talker device.

13. The system of claim 11, wherein the interface device is communicatively connected to the listener device and is configured to receive and display information corresponding to the collected AVB protocol data collected at one or more of the talker device and the listener device.

14. The system of claim 10, wherein the collected AVB protocol data includes data collected from one or more messages transmitted during clock synchronization according to precision time protocol (PTP).

15. The system of claim 10, wherein the collected AVB protocol data includes data collected from one or more messages transmitted during a stream reservation process according to stream reservation protocol (SRP).

16. The system of claim 10, wherein the collected AVB protocol data includes data collected from one or more messages transmitted during performance of traffic shaping according to IEEE 802.1Qav.

17. The system of claim 10, wherein the collected AVB protocol data includes data collected from one or more messages transmitted in accordance with audio video transport protocol (AVTP).

18. The system of claim 10, wherein the interface system includes a user interface for accepting user input, the interface system further comprising instructions executable by a processor of the interface system to transmit a control command via the AVB network to adjust AVB parameters according to user input.

19. A method for diagnosing errors in an AVB communication system, the method comprising:
collecting, via an interface device of the AVB communication system, AVB protocol data from one or more diagnostic modules in an AVB communication system, each of the one or more diagnostic modules being included in a talker or a listener device of the AVB communication system;
analyzing the collected data to determine whether errors are present in the AVB communication system; and
displaying, via a display device of the interface device, the collected data including an indication of any errors determined to be present during analysis of the collected data.

20. The method of claim 19, wherein analyzing the collected data comprises comparing data collected from one or more PTP, SRP, Qav, and AVTP messages to expected data and identifying differences in the collected data from the expected data that exceed a threshold.
